(19) United States
(12) Patent Application Publication
(10) Pub. No.: US 2017/0020779 A1
(43) Pub. Date: Jan. 26, 2017

(54) MONITORING AND FEEDBACK FOR RESUSCITATION

(71) Applicant: Nonin Medical, Inc., Plymouth, MN (US)

(72) Inventors: Gregory J. Rausch, Minnetonka, MN (US); Matthew Prior, Plymouth, MN (US); Philip O. Isaacson, Chanhassen, MN (US)

(21) Appl. No.: 15/217,713

(22) Filed: Jul. 22, 2016

Related U.S. Application Data
(60) Provisional application No. 62/196,163, filed on Jul. 23, 2015.

(51) Int. Cl. A61H 31/00

(52) U.S. Cl. CPC A61H 31/006; A61H 31/005; A61H 2230/207

(57) ABSTRACT

A method, a system, or an apparatus for resuscitation can include a first sensor having a first output configured to provide a first sensor signal corresponding to optical attenuation of tissue at a site. The method, the system, or the apparatus can include a processor coupled to the first output. The processor can be configured to generate an output signal. The output signal can be determined based on a first parameter of the optical attenuation. The first parameter can correspond to blood circulation associated with externally applied stimulation of a cardiovascular organ. The method, the system, or the apparatus can include a system output coupled to the processor. The system output can be configured to provide a control signal determined using the output signal.

### CLAIM OF PRIORITY

This application claims the benefit of priority of U.S. Provisional Application 62/196,163, filed Jul. 23, 2015, which is herein incorporated by reference in its entirety.

### BACKGROUND

Cardiopulmonary resuscitation (“CPR”) may be performed on a patient, such as by a health care provider. CPR may be necessary to prevent an organ, such as the brain or heart, from becoming hypoxic, such as in the event of cardiac arrest. CPR may be difficult for the health care provider to administer. Current CPR techniques are inadequate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Such embodiments are demonstrative and not intended to be exhaustive or exclusive embodiments of the present apparatuses, systems, or methods.

FIG. 1 illustrates an example of a block diagram of resuscitation system.

FIG. 2 illustrates a pictorial example of signal information.

FIG. 3 illustrates an example of a method for resuscitation.

FIG. 4 illustrates an example of a method for resuscitation.

FIG. 5 illustrates an example of a method for resuscitation.

FIG. 6 illustrates a pictorial example of a system for resuscitation.

### DETAILED DESCRIPTION

A system for resuscitation can provide a first sensor signal. The system can provide a second sensor signal. Information from the first and second sensor signals can be used to determine an output signal. The output signal can be used to determine a control signal. A cardiopulmonary resuscitation (“CPR”) device can be configured to exert a force based on the control signal. The CPR device can be used to resuscitate a patient. The present subject matter can improve CPR techniques.

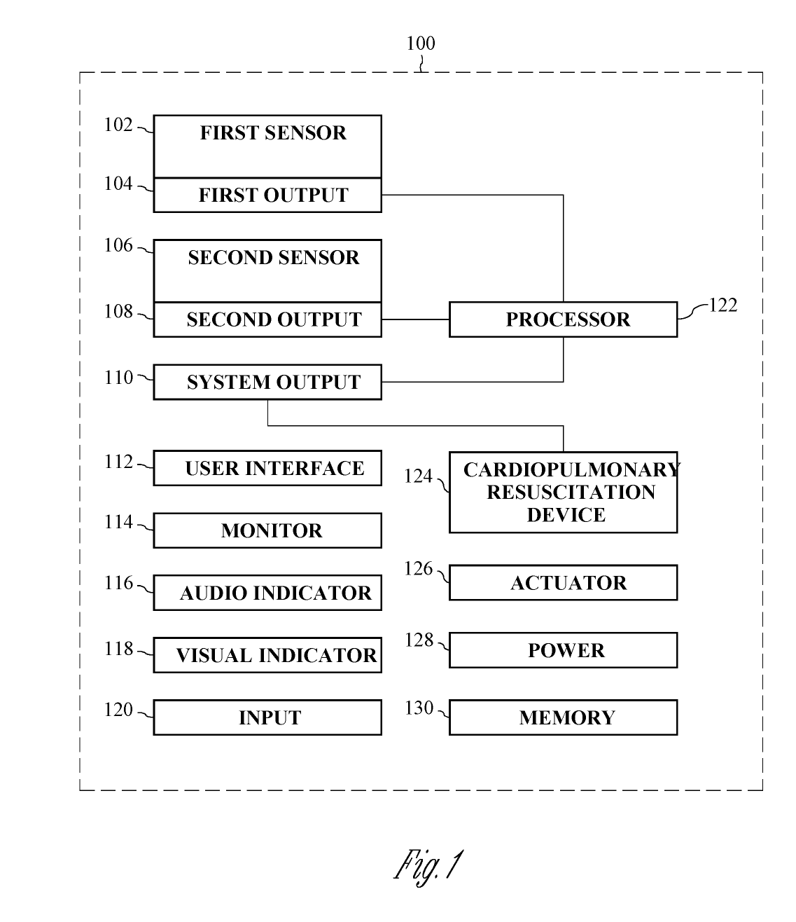

FIG. 1 illustrates an example of a block diagram of resuscitation system 100. The resuscitation system 100 includes a first sensor 102. The first sensor 102 has a first output 104. The resuscitation system 100 includes a second sensor 106. The second sensor 106 has a second output 108. The resuscitation system 100 includes a processor 122. The processor 122 can be coupled to the first output 104, the second output 108, and a system output 110. The system output 110 can be coupled to the CPR device 124.

The resuscitation system 100 can include a user interface 112, a monitor 114, an audio indicator 116, a visual indicator 118, an input 120, an actuator 126, a power supply 128, and a memory 130. The resuscitation system 100 can include other elements.

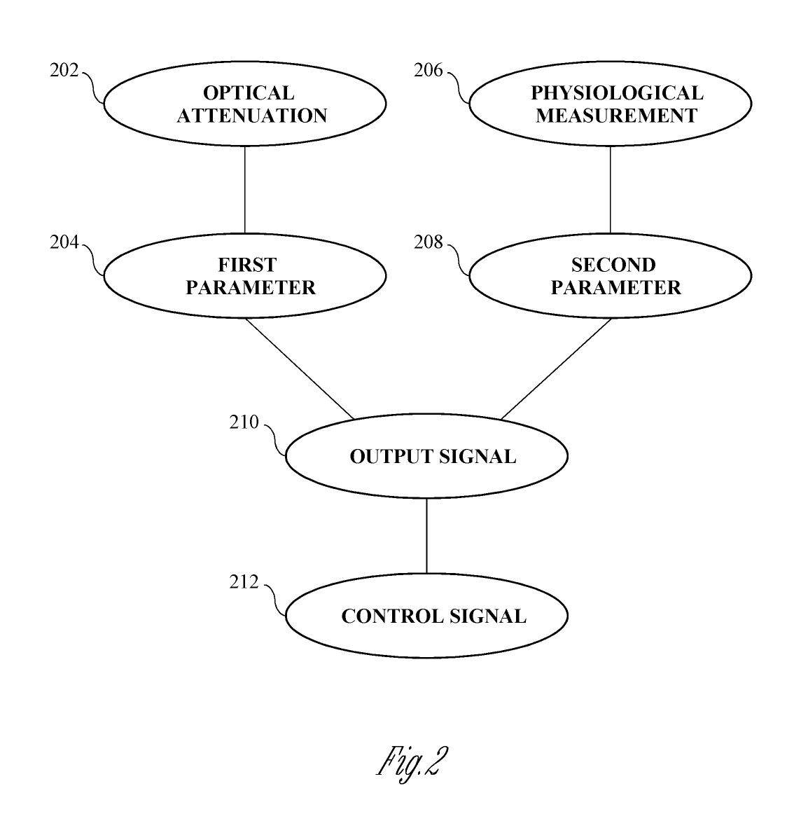

FIG. 2 illustrates a pictorial example of signal information. The first output 104 is configured to provide a first sensor signal corresponding to optical attenuation 202 of tissue at a first site. A site can be a location, region, target, or fiducial on the patient. The first sensor signal is used to determine oxygenation. In an example, the first sensor is a regional oximetry sensor (also referred to as an “rSO2 sensor”). An rSO2 measurement can be associated with an arterial oxyhemoglobin level and a venous oxyhemoglobin level. The rSO2 measurement can be associated with oxygen consumption of the tissue at the first site. The first site can relate to the patient's brain, such as the frontal cortex. A first parameter 204 of the optical attenuation 202 can be determined, such as by using the processor 122. The first parameter 204 corresponds to blood circulation associated with externally applied stimulation of a cardiovascular organ. The cardiovascular organ can be the heart of the patient, or another organ. In an example, the first parameter 204 corresponds to a rate, such as a compression rate provided by the CPR device 124.

In an example the first sensor 102 includes an emitter configured to emit light, and a photodetector configured to detect light. The first sensor signal is determined using information from the light detected by the photodetector.

The second sensor 108 can be positioned at a second site. The second site can correspond to the first site. Or, in an example, the second site can be elsewhere on the patient. In an example, the second site is a nasal region of the patient. The second sensor 108 can be a cannula. In an example, the second sensor is configured to measure end-tidal carbon dioxide (also referred to as “EtCO2”). EtCO2 can correspond to the level of carbon dioxide at the end of an exhaled breath of the patient. In an example, the cannula is a capnograph. The EtCO2 measurement can be taken during CPR of the patient. The EtCO2 measurement can provide an indication of oxygen consumption by the patient, as carbon dioxide can be expelled at a rate that correlates with oxygen consumption. A second sensor signal can correspond to a physiological measurement 206, such as the EtCO2 measurement for example. The second sensor can provide a signal to indicate detection of exhaled breath. In various examples, the second sensor can include a thermistor, a flow meter, a microphone, a pressure sensor, or other sensor. A second parameter 208 of the physiological measurement 206 can be determined, such as by using the processor 122.

An output signal 210 can be determined based on at least one of the first parameter or second parameter. A control signal 212 can be determined using the output signal 210. The control signal 212 can be provided, such as by using the system output 110, to the CPR device 124, for example.

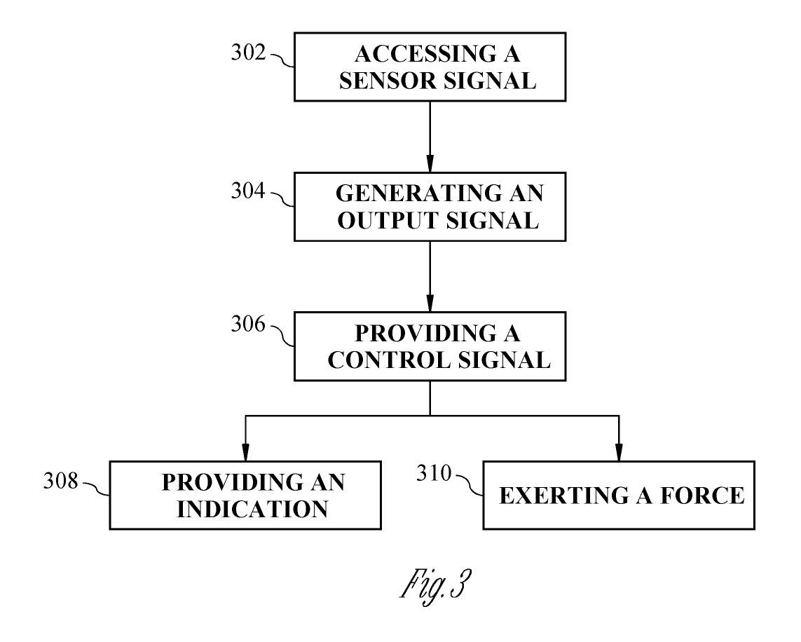

FIG. 3 illustrates an example of a method for resuscitation. At 302, a sensor signal is accessed. In an example, the sensor signal is the first sensor signal that corresponds to the first parameter. The sensor signal can be accessed by the processor 122. At 304, the output signal 210 is generated, such as by using the processor 122. The output signal 210 can be modified (e.g., adjusted, filtered, or processed), such as to provide a desired type of signal or desired signal information. At 306, the control signal 212 is provided, such as by using the system output 110.

At 308, an indication is provided, such as by using the monitor 114, the audio indicator 116, or the visual indicator 118. The indication can be configured to inform a health care provider (e.g., a physician, a CPR administrator, a CPR device operator, or a bystander) to adjust the administration of CPR to the patient. In an example, the indication can instruct the health care provider to increase or decrease the rate of compression, or increase or decrease the depth of compression. In an example, an accelerometer is coupled to the chest and provides an indication of compression. For example, an accelerometer can provide a signal to indicate the depth of compression, frequency of compression, or duration of compression. In addition, accelerometer data can be fused with rSO₂ data SpO₂ data, or EtCO₂ data. In an example, the control signal 212 is provided to the monitor 114, to control information on a screen or display of the monitor 114.

At 310 a force is exerted, such as by using the CPR device 124. The CPR device 124 can include the actuator 126. The CPR device 124 can receive the control signal 212, such as to control the operation of the CPR device 124. The CPR device 124 exerts a force on the patient. The CPR device 124 can provide uniform CPR, such as a constant rate or constant amplitude of compression. The CPR device 124 can be configured to maintain homeostasis of the patient. The CPR device 124 can be configured to modulate at least one of the first or second parameters, such as by increasing or decreasing a value of the first or second parameters.

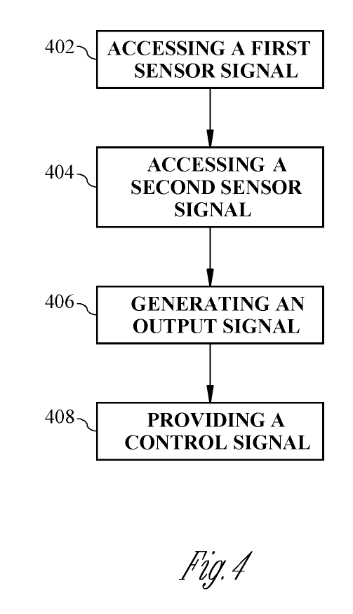

FIG. 4 illustrates an example of a method for resuscitation. At 402, the first sensor signal is accessed, such as by using the processor 122. At 404, the second sensor signal is accessed, such as by using the processor 122. At 406, an output signal, such as the output signal 210, is generated, such as by using the processor 122. At 408, a control signal, such as the control signal 212, is provided, such as by using the system output 110.

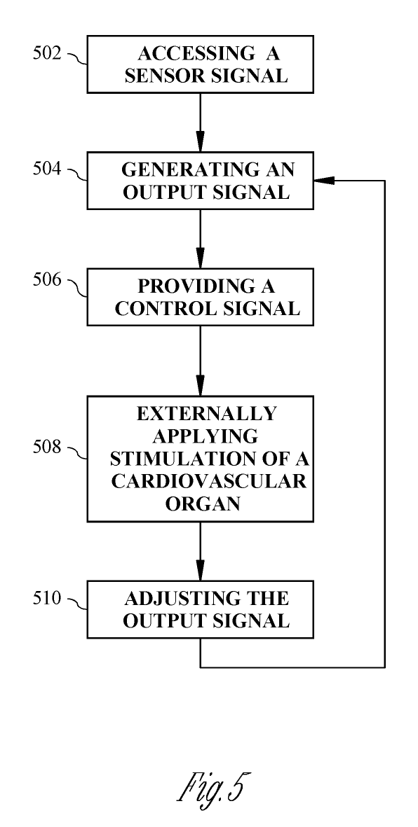

FIG. 5 illustrates an example of a method for resuscitation. At 502, a sensor signal is accessed. At 504, an output signal is generated. At 506, a control signal is provided. At 508, externally applied stimulation of a cardiovascular organ occurs. At 510, the output signal is adjusted. In an example, the CPR device 124 can provide dynamic CPR, such as in response to a modification of the output signal caused by a state of the patient. In this way, feedback information about the patient state can be used to modify the control signal 212 provided to the CPR device 124, such as to improve treatment.

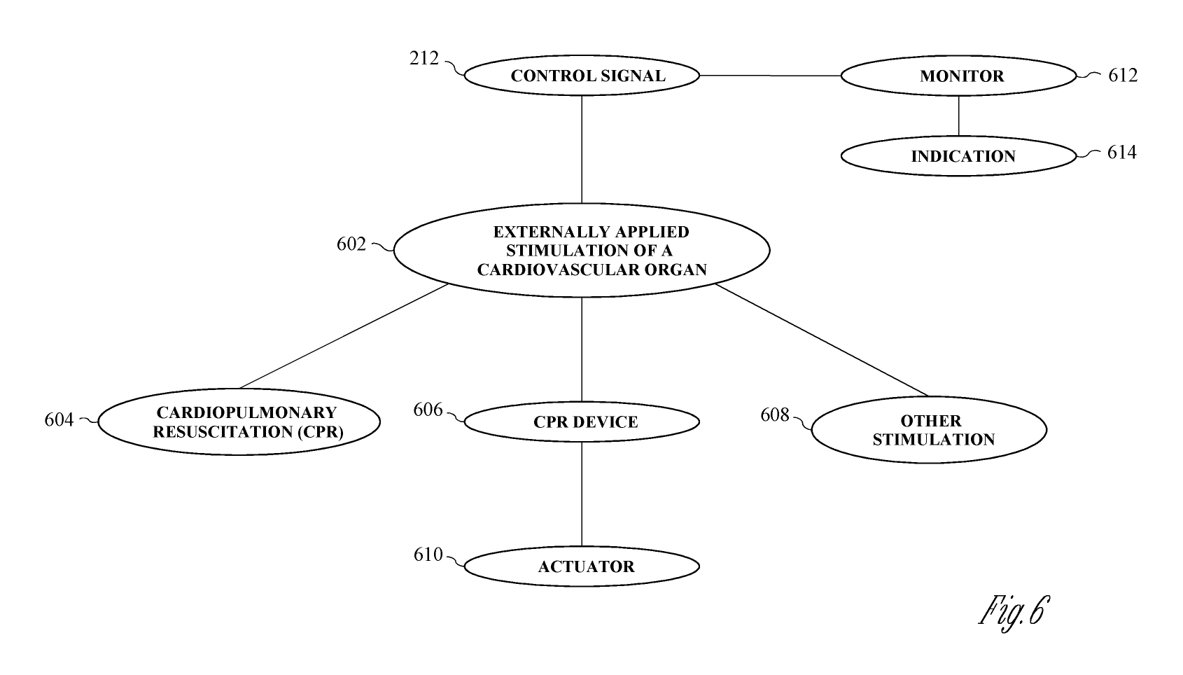

FIG. 6 illustrates a pictorial example of a system for resuscitation. The control signal 212 can be provided to a monitor 612, such as the monitor 114. In an example, the monitor can be configured to provide an indication 614. The control signal 212 can be provided, such as to provide control for externally applied stimulation of a cardiovascular organ 602. In a conceptual example, the externally applied stimulation of the cardiovascular organ 602 can include performing CPR 604, such as by a health care provider; using a CPR device 606 including an actuator 610; or other stimulation 608 of the cardiovascular organ.

### Additional Notes

In an example, the first sensor 102 is a regional oximeter configured to determine tissue oxygenation (also referred to as “rSO2”). In an example, the first sensor 102 is configured to monitor AC signals. In an example, the first sensor 102 is a pulse oximeter.

In an example, an element of the resuscitation system 100 can be coupled to another element of the resuscitation system 100, such as by using a link (e.g., an electric conductor or a bus). In an example, the resuscitation system 100 can be comprised of a single apparatus, such as by using a housing. In an example, there can be two or more devices coupled to one another, such as wired or wirelessly. In an example, a first device can include the first sensor 102, and a second device can include the CPR device 124. Any element of the resuscitation system 100 can be external to the first device, such as internal to the second device. Any element of the resuscitation system 100 can be coupled to another element, such as wired or wirelessly.

The power supply 128 can distribute power to different elements of the resuscitation system 100, such as the sensors, the processor 122, the actuator 126, or the monitor 114. The memory 130 is coupled to the processor 122. The input 120 is coupled to the processor.

In an example, the present subject matter can include a remote device. The remote device can include a wireless transceiver configured to wirelessly communicate with a wireless transceiver of a controller. The controller can transmit to the remote device, and the remote device can transmit to the controller. In an example, the present subject matter can include the monitor 114, such as to provide audio or visual indications to a user, such as a health care provider. In an example, the resuscitation system 100 can provide information to an external device, such as by using the system output 110 (e.g., such as to provide information to a treatment device).

In an example, the monitor 114 is configured to provide feedback to the health care provider, such as about the effectiveness of administered CPR. The monitor 114 can be configured to attach to the patient, such as by using a head worn strap. The monitor 114 can be handheld. The monitor 114 can be an external device. In an example, the monitor 114 is battery powered. Feedback can be provided in a variety of formats. For example, audible feedback can correspond to a measured parameter such as a rate, a duration, a depth, or a calculated parameter such as efficiency or time. In addition, feedback can be visual and include presentation of a numerical value or a graded value to indicate progress or performance. In addition, visual feedback can take the form of a trend line or graphical representation.

In an example, at least one of the first site or the second site is or corresponds to the head, the brain, an eye, a neck, a torso, an arm, a digit such as a finger, a leg, a foot, or another region on the patient.

In an example, the second sensor 106 includes a temperature sensor. In an example, the second sensor 106 includes a gas sensor. In an example, the gas sensor includes a carbon dioxide sensor. In an example, the second sensor 106 includes an accelerometer. In an example, the second sensor 106 includes an electrocardiogram (“EKG” or “ECG”) sensor. In an example, the second sensor 106 includes an electroencephalography (“EEG”) sensor. In an example, the second sensor 106 includes a pressure sensor. In an example, the second sensor 106 includes an optical sensor.

In an example, the processor 122 is configured to implement an attenuator. In an example, the processor 122 is configured to implement a filter. In an example, the processor 122 is configured to implement an amplifier.

In an example, the user interface 112 includes a speaker. In an example, the user interface 112 includes a plurality of light emitters. In an example, the user interface 112 includes the actuator 126. In an example, the system output 110 is coupled to a wireless transmitter. In an example, the system output 110 includes an electrical connector. In an example, the first sensor 102 includes an optical detector.

In an example, the processor 122 is configured to determine real time blood absorbance. The monitor 114 can display a real time blood absorbance graph.

In an example, at least one of the first sensor 102 or the second sensor 106 can be configured to run at a rate (e.g., a sampling rate). The rate can be 7 Hertz. The rate can be less than 7 Hertz. The rate can be greater than 7 Hertz. In one example, the rate is 9.375 Hertz. In an example, the rate is 75 Hertz. Other specified rate options are available.

The resuscitation system 100 can include an amplifier. The processor 122 can be configured to determine a direct current (“DC”) component of a signal. The amplifier can amplify a particular component of the signal, such as an alternating current (“AC”) component.

In an example, at least one of the first parameter 204 or second parameter 208 can be determined using the processor 122. The processor 122 can use information from the first sensor signal or second sensor signal to determine the respective parameter. In an example, a parameter (e.g., the first or second parameter) can be based on a width of a pulsatile component of a signal, such as can be correlated with total oxygen delivery. The pulsatile signal can be processed, such as to determine an area under the curve of the signal, such as can be correlated with total oxygen delivery. In an example, a derivative signal can be determined. In an example the derivative signal is determined for the pulsatile component of the signal, and the derivative signal can be used to determine the parameter. In an example, the derivative signal can be correlated with the quickness of compression, such as provided by the CPR device 124 or by administered CPR by a health care provider. The parameter can be determined, such as by using information about zero crossings of the signal (e.g., on a graphical axis, or relative to an independent variable). In an example, a spectral analysis can be performed on the signal, such as to determine the parameter. In one example, the parameter corresponds to a pressure wave. There are other functions, equations, or processing systems that can be used to determine the parameter. In an example, any one or any combination of these examples to determine the parameter can be used, such as determined using the processor 122.

In an example, an apparatus for resuscitation can include the processor 122 that is configured to use two or more signals to control the CPR device 124.

In an example, the apparatus for resuscitation can include the processor 122 that is configured to determine parameter derived from the control signal, wherein the control signal controls the CPR device 124.

In an example, the derivative signal can be used to determine a cardiac output, a pulse wave velocity, a pulse transit time, or another derivative signal.

Information about compressions being performed on the patient (e.g., such as by the CPR device 124 or by the health care provider) can be determined. In an example the information about compressions being performed can include rate, depth, quickness, a return to baseline (e.g., when the lungs return to a base state), or other information.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided.

Each of these non-limiting examples can stand on its own, or can be combined in various permutations or combination with one or more of the other examples.

Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, an apparatus, system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus for resuscitation, the apparatus comprising:
a first sensor having a first output configured to provide a first sensor signal corresponding to optical attenuation of tissue at a first site;
a processor coupled to the first output, the processor configured to generate an output signal, wherein the output signal is determined based on a first parameter of the optical attenuation, and wherein the first parameter corresponds to blood circulation associated with externally applied stimulation of a cardiovascular organ; and
a system output coupled to the processor, the system output configured to provide a control signal determined using the output signal.

2. The apparatus of claim 1 comprising a cardiopulmonary resuscitation (CPR) device coupled to the system output.

3. The apparatus of claim 2 wherein the CPR device is configured to exert a force based on the control signal.

4. The apparatus of claim 2 wherein the CPR device includes an actuator configured to provide physical compression.

5. The apparatus of claim 4 wherein the actuator includes at least one of a hydraulic actuator, a pneumatic actuator, or an electric actuator.

6. The apparatus of claim 1 further including a second sensor having a second output configured to provide a second sensor signal corresponding to a physiological measurement at a second site, and wherein the processor is coupled to the second output.

7. The apparatus of claim 6 wherein the second sensor includes a cannula.

8. The apparatus of claim 6 wherein the processor is configured to determine a second parameter of the physical measurement, and wherein the output signal is determined based on the second parameter.

9. The apparatus of claim 1 wherein the processor is configured to determine oxygenation based on the first sensor signal.

10. The apparatus of claim 1 wherein the output signal corresponds to a change in a rate of the externally applied stimulation of the cardiovascular organ.

11. The apparatus of claim 1 wherein the output signal corresponds to a change in an amplitude of the externally applied stimulation of the cardiovascular organ.

12. The apparatus of claim 1 wherein the output signal corresponds to a comparison of the first parameter and a reference value, and wherein the processor is configured to select the reference value based on stored data accessible to the processor.

13. A method for resuscitation, the method comprising:
accessing a first sensor signal corresponding to optical attenuation of tissue at a first site;
generating an output signal, wherein the output signal is determined based on a first parameter of the optical attenuation and wherein the first parameter corresponds to blood circulation associated with externally applied stimulation of a cardiovascular organ; and
providing a control signal determined using the output signal.

14. The method of claim 13 further comprising exerting a force using a cardiopulmonary resuscitation (CPR) device, wherein the CPR device is configured to exert the force based on the control signal.

15. The method of claim 13 further comprising accessing a second sensor signal corresponding to a physiological measurement at a second site; and
wherein the output signal is determined using the physiological measurement.

16. The method of claim 13 further comprising adjusting the output signal using at least one of a change in a rate and a change in an amplitude, of the externally applied stimulation of the cardiovascular organ.

17. The method of claim 13 further comprising providing at least one of an audible indication and a visual indication, based on the output signal.

18. A system for resuscitation, the system comprising:
a first sensor having a first output configured to provide a first sensor signal corresponding to optical attenuation of tissue at a first site;
a processor coupled to the first sensor, the processor configured to generate an output signal, wherein the output signal is determined based on a first parameter of the optical attenuation, and wherein the first parameter corresponds to blood circulation induced by externally applied stimulation of a cardiovascular organ;
wherein the processor is configured to determine the first parameter based on a function of a waveform of a pulsatile component of the first sensor signal;
a system output coupled to the processor, wherein the system output is configured to provide a control signal determined using the output signal; and
a cardiopulmonary resuscitation (CPR) device coupled to the system output, the CPR device configured to exert a force.

19. The system of claim 18 wherein the CPR device is configured to receive the control signal, and wherein the CPR device is exert the force using the control signal; and
wherein the CPR device includes an actuator configured to provide physical compression.

20. The system of claim 18 wherein the output signal corresponds to a comparison of the first parameter and a reference value and wherein the processor is configured to select the reference value based on stored information accessible to the processor.
